(19) United States
(12) Patent Application Publication
(10) Pub. No.: US 2012/0107722 A1
(43) Pub. Date: May 3, 2012

(54) SEPARATOR AND FUEL CELL USING THE SAME

(75) Inventors: Hiroyuki SATAKE, Mito (JP); Masaya KOZAKAI, Hitachinaka (JP); Kenji YAMAGA, Hitachi (JP)

(73) Assignee: Hitachi, Ltd.

(21) Appl. No.: 13/286,256

(22) Filed: Nov. 1, 2011

(30) Foreign Application Priority Data
Nov. 2, 2010 (JP) 2010-245864

(51) Int. Cl. H01M 8/04; H01M 8/10

(52) U.S. Cl. 429/492; 429/514

(57) ABSTRACT

A separator for a fuel cell includes a metal separator (metal substrate) having projections formed by ribs, and porous members provided in a plurality of flow passages partitioned by the projections, in which a hydrophilic portion is provided in a center part of a cross section orthogonal to a flow direction in the porous member, and a water repellent portion is provided in at least a part of portions in contact with wall surfaces of the flow passage within a range of the cross section.

According to the present invention, the mixed phase flow in which the reaction gas and the cooling water inside the flow passages are mixed can be made an even flow in the separator in which the porous members are provided in the gas flow passages.

### CLAIM OF PRIORITY

The present application claims priority from Japanese Patent application serial No. 2010-245864, filed on Nov. 2, 2010, the content of which is hereby incorporated by reference into this application.

### BACKGROUND OF THE INVENTION

1. Field of the Invention

The present invention relates to a separator formed of a metal substrate and a fuel cell using the same.

2. Description of Related Art

A fuel cell is for supplying electricity by making fuel gas and oxidant gas electrochemically react with each other, and is hoped as a new energy because of the merits that it is high in power generation efficiency, excellently silent, and low in the emission amount of NOx and SOx which become the cause of air pollution and CO₂ which becomes the cause of global warming and so on.

The separator is one of the important constituents of the fuel cell. The separator has a flow passage structure devised so as to separate the fuel gas and oxidant gas and to allow the gas to evenly spread to electrodes, and includes flow passages for cooling for removing the heat of reaction generated accompanying power generation. As a separator for a fuel cell, there are two kinds. One is a separator including a flow passage for reaction gas, and the other is a separator having a flow passage for cooling. Usually, these separators are respectively manufactured individually. However, in these days, a separator has been developed in which porous members are arranged in the gas flow passages, a mixed phase flow in which the cooling water is mixed along with the reaction gas is made flow in the flow passage, and supply of the reaction gas to the electrodes and discharge of the heat of reaction take place in one flow passage.

In order to discharge the heat of reaction, it is effective to use a porous material with high specific surface area and to utilize the heat of vaporization of the cooling water mixed in, and the power generation efficiency can be improved because required cooling can be achieved by mixing of less amount of the cooling water. However, with respect to cooling by the heat of vaporization, although remarkable cooling effect can be obtained, the defects are caused that uneven cooling occurs when the flow is uneven, and that not only the cooling efficiency drops but also the cooling water covers the electrode portions and the reaction gas cannot be supplied to the electrodes.

Accordingly, in the flow passages where the porous members are provided, some arrangement of making the cooling water flow evenly is required.

As the prior arts in which the porous members are provided in the gas flow passages and the flow control of the phase mixture of the reaction gas and the cooling water is performed by water repellent and hydrophilic treatment, the followings can be cited.

Japanese Unexamined Patent Application Publication No. 2007-328975 (Document 1) discloses a fuel cell including reaction gas flow passage blockage suppressing portions which include a part of reaction gas discharging portions within a range of a plurality of reaction gas discharging portions corresponding to openings of a plurality of reaction gas discharging communication holes, in which water repellency of the reaction gas flow passage blockage suppressing portions is enhanced.

Japanese Unexamined Patent Application Publication No. 2006-134582 (Document 2) discloses a fuel cell in which a cross-sectional area of a gas flow passage in generally orthogonal direction with respect to the gas flow direction is constituted so as to decrease from upstream the gas flow passage toward downstream.

Japanese Unexamined Patent Application Publication (Translation of PCT Application) No. 2009-538509 (Document 3) discloses a fuel cell including transporting elements unifying a hydrophilic region and a water repellent region, in which the hydrophilic region and the water repellent region are alternately arranged in a mottled pattern, the hydrophilic region allows transportation of water, and the water repellent region allows air to pass through.

Japanese Unexamined Patent Application Publication No. 2007-234590 (Document 4) discloses a fuel cell including a water absorption layer and an oxygen supply layer, in which the hydrophilic property of the material forming the water absorption layer is higher than the hydrophilic property of the material of the oxygen supply layer.

### SUMMARY OF THE INVENTION

A separator for a fuel cell in relation with the present invention includes a metal substrate having projections and porous members provided in a plurality of flow passages partitioned by the projections, in which a hydrophilic portion is provided in a center part of a cross section orthogonal to a flow direction in the porous member, and a water repellent portion is provided in at least a part of portions in contact with wall surfaces of the flow passage within a range of the cross section.

According to the present invention, the mixed phase flow in which the reaction gas and the cooling water inside the flow passages are mixed can be made an even flow in the separator for the fuel cell in which the porous members are provided in the gas flow passages.

### BRIEF DESCRIPTION OF THE DRAWINGS

FIG. 1 is a front view showing a metal separator manufactured by press forming.

FIG. 2A is a front view showing a separator for a fuel cell of an example which has porous members.

FIG. 2B is a perspective view showing the porous member of the example.

FIG. 2C is a cross-sectional view showing the porous member of FIG. 2B.

FIG. 3 is a perspective view showing a shape model of the porous member used in simulation.

FIG. 4 is a perspective view showing a porous flow passage model used in the simulation.

FIG. 5 is a top view showing an example of an analytical result by the simulation.

FIG. 6 is a cross-sectional view taken from line A-A of FIG. 5.

FIG. 7 is a graph for analyzing the analytical result by the simulation.

FIG. 8 is a cross-sectional view showing the ratio of the water repellent treatment region which is an analytical condition.

FIG. 9 is a graph for analyzing and comparing the analytical result by the simulation.

FIG. 10A is a front view showing a separator for a fuel cell of an example.

FIG. 10B is a perspective view showing a porous member of the example.

FIG. 10C is a cross-sectional view showing the porous member of the example.

FIG. 11A is a perspective view showing a constitution of the water repellent treatment region of the porous member of an example.

FIG. 11B is a cross-sectional view showing a constitution of the water repellent treatment region of the porous member of the example.

FIG. 11C is a perspective view showing a constitution of the water repellent treatment region of the porous member of another example.

FIG. 11D is a cross-sectional view showing a constitution of the water repellent treatment region of the porous member of the example.

FIG. 12A is a front view showing a fuel pole side separator of another example.

FIG. 12B is a front view showing a gasket of the example.

FIG. 12C is a front view showing a membrane-electrode assembly of the example.

FIG. 12D is a front view showing the gasket of the example.

FIG. 12E is a front view showing an air pole side separator of the example.

FIG. 12F is a top view showing a cell for a fuel cell of the example.

### DETAILED DESCRIPTION OF THE PREFERRED EMBODIMENTS

The fuel cell in relation with the present invention is useful as a stationary power source and a movable power source.

The control of the mixed phase flow in the porous flow passages by water repellent and hydrophilic treatment in the prior arts relates to prevention of blockage at the outlet portion by liquid water, prevention of flooding in the electrode portions, and material transportation by separation of the reaction gas channel and the liquid water channel, and there is a room for improvement from the viewpoint of achieving evenness of the reaction gas flow and the liquid water flow.

The object of the present invention is to control the mixed phase flow in which the reaction gas and the cooling water in the flow passages are mixed and to make the cooling water inside the porous flow passages flow evenly in a separator for a fuel cell in which the porous members are provided in the gas flow passages.

In general, the porous member has attributes such as the pore diameter, the pore diameter distribution and the like, and the mixed phase flow in which the reaction gas and the cooling water are mixed by adjusting the attributes is considered to be controllable. However, it is difficult to clarify the relation between the pore diameter and the pore diameter distribution and the mixed phase flow, and to adjust the pore diameter and the pore diameter distribution of the porous member and to manufacture the porous member so that the flow of the cooling water becomes even. Further, machining of the porous member is hard, and it is also difficult to groove or to stick together the porous members with the different pore diameter and the pore diameter distribution.

Therefore, it was decided to study the possibility of performing the porous member with the water repellent treatment or hydrophilic treatment such as Teflon (registered trademark) coating, a plasma treatment and the like and controlling the flow of the mixed phase flow in which the reaction gas and the cooling water were mixed. According to the method, adjustment of the pore diameter and the pore diameter distribution and machining are not required, and the flow of the mixed phase flow in the porous flow passages can be easily controlled.

Below, a separator and a fuel cell using the same in relation with an embodiment of the present invention will be described.

The separator for the fuel cell includes a metal substrate having projections and porous members provided in a plurality of flow passages partitioned by the projections, in which a hydrophilic portion is provided in a center part of across section orthogonal to a flow direction in the porous member, and a water repellent portion is provided in at least a part of portions in contact with wall surfaces of the flow passage within a range of the cross section.

In the separator, it is preferable that the water repellent portion is a region occupying 40% or less of the porous member in terms of a volumetric ratio and the water repellent portion is provided dividedly to both ends in the width direction, and a width of the water repellent portions in the both ends are 0.2×b or less respectively when a width of the cross section is b.

In the separator, the water repellent portion is the region occupying 40% or less of the porous member in terms of a volumetric ratio, and is arranged so that the volumetric ratio of the water repellent portion becomes constant, increases, or decreases toward a downstream side in the flow direction.

In the separator, the height of the cross section is a depth of the flow passages or less.

The fuel cell contains a membrane-electrode assembly which includes a fuel pole, an oxygen pole and a solid polymer electrolyte membrane and has a constitution of interposing the solid polymer electrolyte membrane between the fuel pole and the oxygen pole, a fuel pole separator having a fuel gas flow passage along the fuel pole and electrically connected to the fuel pole, and an oxygen pole separator having an oxidant gas flow passage along the oxygen pole and electrically connected to the oxygen pole, in which the fuel pole separator or the oxygen pole separator is the separator for the fuel cell.

Below an example will be described referring to drawings.

### Example

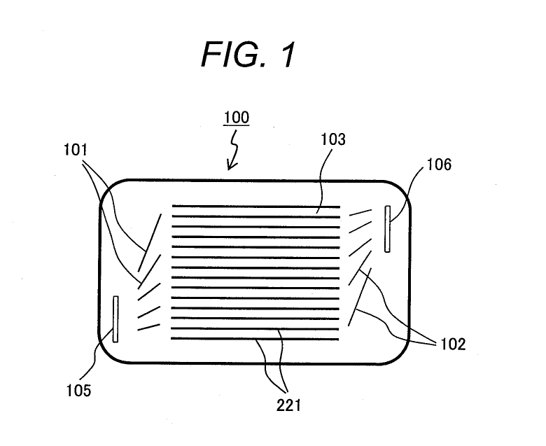

FIG. 1 is a front view showing a metal separator which is a substrate of a separator for a fuel cell.

The separator for the fuel cell has a flow passage structure devised so that the reaction gas reaches the electrodes evenly, and includes flow passages for the cooling water for discharging the heat of reaction generated accompanying power generation in the electrodes. In an ordinary separator for a fuel cell, the flow passage for the reaction gas and the flow passage for the cooling water are respectively manufactured individually. In the separator for a fuel cell using the metal separator 100 shown in the present drawing, however, supply of the reaction gas and supply of the cooling water are achieved by one flow passage.

The metal separator 100 is manufactured by a press forming.

In the present drawing, the metal separator 100 (metal substrate) includes projections formed of flow amount controlling parts 101, 102, ribs 221 and the like. Except the projections, the metal separator 100 is of a shape of a flat plate.

The flow amount controlling parts 101, 102 are the projections constituting a plurality of flow passages to divide the gas flow so that the gas flows evenly over the entire region of the flow passages. Reaction gas/cooling water supply passages 103 formed by the ribs 221 allow the porous member to be embedded.

Also, the metal separator 100 includes the reaction gas/cooling water supply passages 103, an inlet manifold 105 through which the gas is poured in, and an outlet manifold 106 through which the gas is discharged.

The metal separator 100 is manufactured, for example, bypressing the metal substrate with 100 mm width, 180 mm length and 0.3 mm thickness, forming the projected ribs 221 with 0.3 mm height and 0.25 mm width to form the flow passage shape, and thereafter punching the inlet and outlet ports allowing the reaction gas and the cooling water to enter and exit (the inlet manifold 105 and the outlet manifold 106). The reaction gas/cooling water supply passages 103 manufactured by pressing are formed of thirteen straight flow passages of 120 mm length, 0.45 mm width and 0.3 mm height (depth).

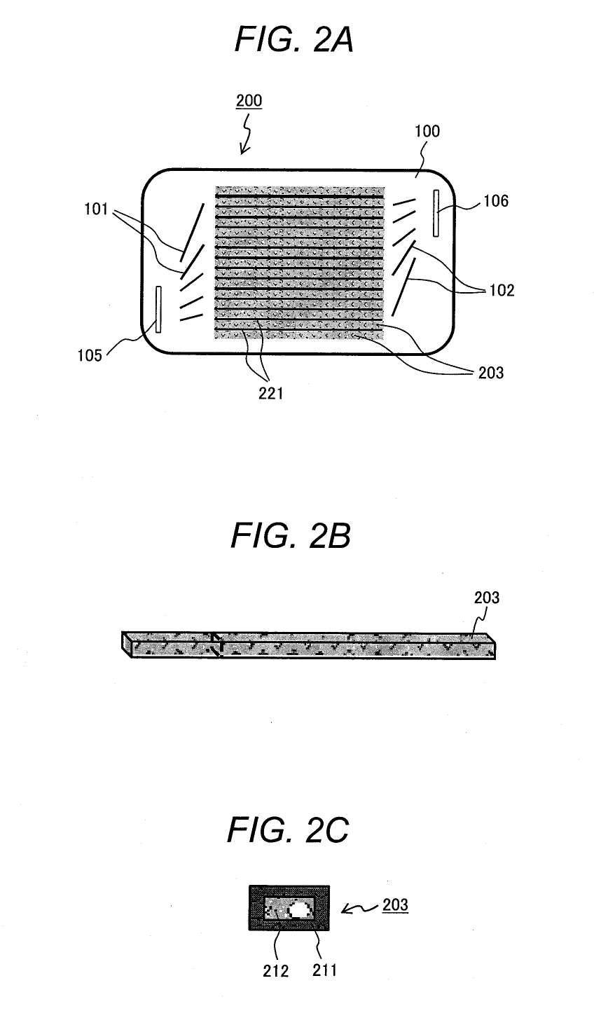

FIG. 2A is a front view showing the separator for a fuel cell of the example.

In the present drawing, a separator for a fuel cell 200 is obtained by providing fifteen pieces of porous members 203 with 120 mm length, 0.45 mm width and 0.3 mm height in the reaction gas/cooling water supply passages 103 provided in the metal separator 100 of FIG. 1.

In the present example, the height (depth) of the reaction gas/cooling water supply passages 103 and the height of the porous members 203 are made equal to each other.

FIG. 2B is a perspective view showing one piece of porous member constituting the separator for a fuel cell of the example. FIG. 2C is a cross-sectional view showing the internal structure of the porous member of FIG. 2B.

In FIG. 2C, the porous member 203 is formed of a water repellent portion 211 and a hydrophilic portion 212. In the present example, the water repellent portion 211 is provided around the hydrophilic portion 212. That is, the annular flow passage of the porous member 203 is the water repellent portion 211. The water repellency of the portions in contact with the wall surfaces of the gas flow passages such as the ribs 221 and the like is enhanced when the porous members 203 are arranged in the reaction gas/cooling water supply passages 103.

Here, the contact angle of water on the surface of the member (porous member) in the water repellent portion is made larger than 90°, and the contact angle of water on the surface of the member (porous member) in the hydrophilic portion is made smaller than 90°. In the present simulation, values were set in the analytical condition assuming an ultra water repellency of the wall surfaces of the water repellent portion with the contact angle of 150° or more, and assuming an ultra hydrophilic property of the wall surfaces of the hydrophilic portion with the contact angle of 0°. Next, an analysis by simulation was performed with respect to the mixed phase flow of the reaction gas and the cooling water in the porous members 203. The calculation result of the flow amount distribution is shown.

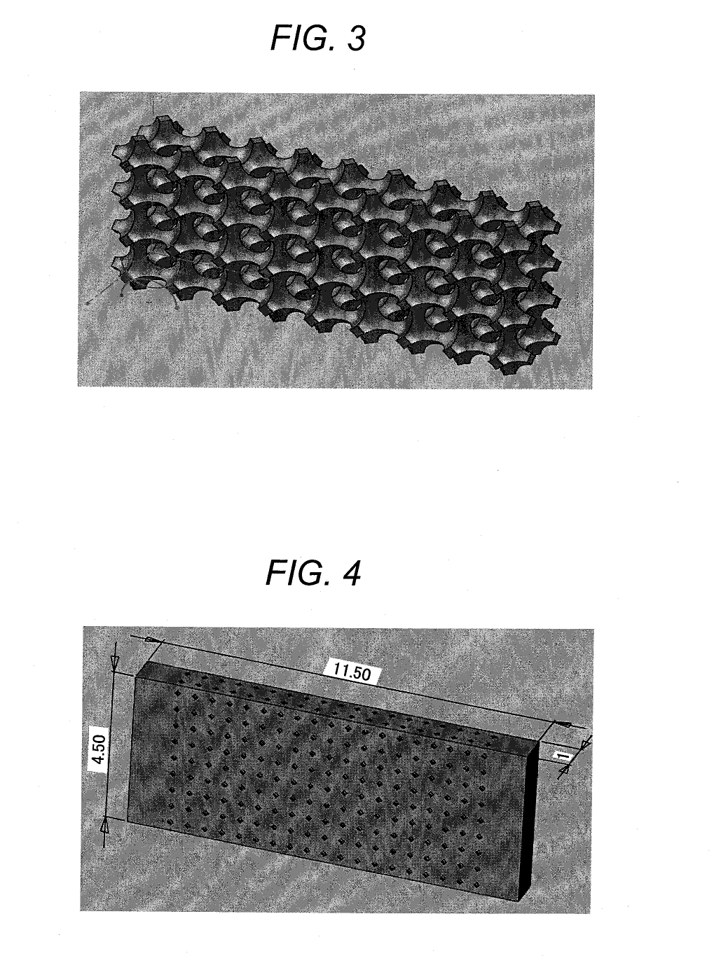

FIG. 3 is a shape of the porous member obtained by three-dimensional modeling.

The three-dimensional shape model was worked out using SolidWorks.

The three-dimensional shape model of the porous member was worked out by adopting the pore diameter of 0.6 mm and arraying the pores in a lattice shape so that the center distance between the pores becomes 0.5 mm. The porosity of the porous member is 73%. By changing the pore diameter and the array, a variety of porous three-dimensional shape models can be worked out, and a porous three-dimensional shape model can be prepared according to the porous member actually used.

FIG. 4 is a three-dimensional shape model of the porous flow passage worked out using the porous three-dimensional shape model of FIG. 3, and was worked out using SolidWorks in a similar manner.

The three-dimensional shape model of the porous flow passage is of a case the porous members modeled in FIG. 3 are arranged in the flow passages with 11.5 mm length, 4.5 mm width and 1.0 mm depth, and shows the region where the reaction gas and the cooling water flow.

Next, a three-dimensional mesh was worked out based on the three-dimensional shape model of the porous flow passage of FIG. 4. In working out the three-dimensional mesh, ICEM CFD (made by ICEM CFD Japan Ltd.) was used. The flow analysis of the mixed phase flow of the reaction gas and the cooling water by simulation was performed using the three-dimensional mesh.

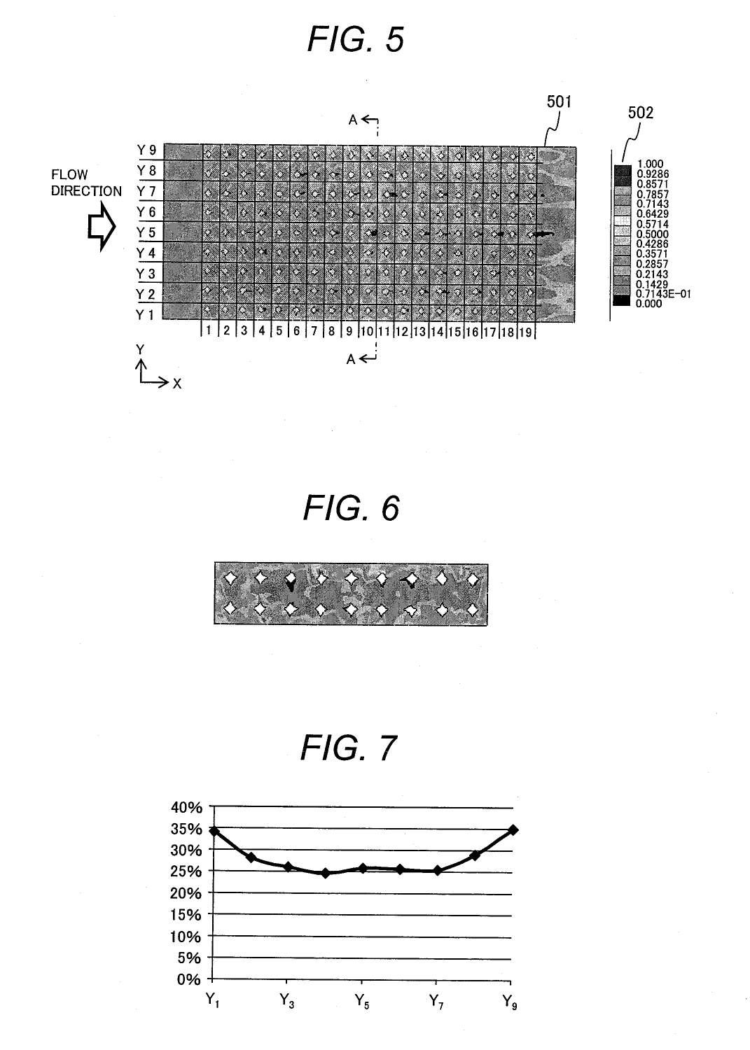

FIG. 5 shows an example of an analytical result of a flow analysis of the mixed phase flow by simulation.

The flow analysis of the mixed phase flow of the reaction gas and the cooling water in the porous flow passages was performed using STAR-CD which was a three-dimensional fluid simulator. With regard to the analytical condition, the pores of 0.6 mm pore diameter shown in FIG. 4 were arrayed in a lattice shape, and the porous flow passages arranged in the flow passages with 11.5 mm length, 4.5 mm width and 1.0 mm depth were used.

With respect to the inlet condition, the air of the normal state is used as the reaction gas, and the water of the normal state was used as the cooling water. The mixed phase flow was poured from the end face of the porous flow passages evenly at the flow velocity of 1 m/s so that the volumetric ratio of the air and the water becomes 7 to 3. With respect to the outlet condition, the mixed phase flow was spontaneously discharged to the atmosphere air from the end face of the porous flow passages opposite to the inlet. Also, as the wall surface condition of the porous flow passages, the wall surfaces were assumed to have been treated with the hydrophilic treatment.

The analytical result of the present drawing shows the distribution of the water inside the flow passages based on a gray scale 502 showing the volume fraction of the water.

From the analytical result of the present drawing, it is known that the mixed phase flow of the air and the water maintains its state that the air and the water are evenly mixed with each other in the vicinity of the inlet of the flow passages (the left end in the drawing) of a porous flow passage region 501 after flowing in from the inlet part in the left end face until being discharged from the outlet part in the right end face, however, as it goes toward downstream, the gaseous phase and the liquid phase are separated from each other and become different flow respectively (uneven flow).

Also, FIG. 6 shows the distribution of the water in a cross-section of the flow passages orthogonal to the flow direction shown in a line A-A in the center part of the flow passages.

From the present drawing, it is known that the water is much distributed to the wall surfaces of the flow passages, and the water is less in the center part of the flow passages. That is, such a tendency is surmised that the mixed phase flow of the air and the water is separated into the gaseous phase and the liquid phase to become the separate flows as it goes downstream, and the liquid phase flows disproportionately in the wall surfaces of the flow passages and the gaseous phase flows disproportionately in the center part of the flow passages.

This result is considered to be a phenomenon caused by that the air and the water are different in density and viscosity, and the flow characteristics are intrinsically different between the air and the water related with the action that the water droplets joined with each other to form larger droplets and the action against the wall surfaces of the flow passages.

Therefore, according to the method of making the mixed phase flow of the reaction gas and the cooling water flow in the porous flow passages, the flows of the gaseous phase and the liquid phase are separated from each other, the water is liable to stay on the wall surfaces of the flow passages and the reaction gas is liable to flow in the center part of the flow passages to cause the disproportionate flow respectively. Accordingly, the reaction gas hardly flows in both ends of the flow passages, and the reaction gas may not be able to be sufficiently supplied to the electrodes. On the other hand, because the water is liable to gather to the wall surfaces of the flow passages, it is probable that sufficient cooling water cannot be supplied to the center part of the flow passages, the heat of reaction is not discharged sufficiently, and uneven cooling is caused.

Next, how the water was distributed disproportionately inside the porous flow passages was analyzed based on the analytical result of FIG. 5. The analysis was performed by dividing the region where the porous members were arranged in the porous flow passage region 501 of FIG. 5 into 9 in the width direction of the flow passages (Y-axis direction) and into 19 in the flow direction of the flow passages (X-axis direction) as shown in FIG. 5 to divide it into 171 elements, obtaining the volume fraction of the water of the respective elements by volume-weighted mean, and thereafter calculating the volume fraction of the water of the respective divided flow passages by volume-weighted mean of the volume fraction of the water of 171 elements with respect to the divided flow passages Y1-Y9 which are obtained by dividing the porous flow passages into 9 in the width direction of the flow passages (Y-axis direction).

An example of the analytical result is shown in FIG. 7.

In the graph shown in the present drawing, the axis of abscissas represents the divided flow passages Y1-Y9, and the volume fraction of the water corresponding to respective divided flow passages are collected in the axis of ordinates. From the graph, it is known that the water is liable to stay in Y1 and Y9 which are both ends of the flow passages, and the water is less in the center part of the flow passages.

From this result also, it is known that the gaseous phase and the liquid phase are separated from each other, the water is liable to stay on the wall surfaces of the flow passages, and the reaction gas is liable to flow in the center part of the flow passages. Further, it is known that the water tends to move in the width direction of the flow passages and the water tends to be present much in both ends of the flow passages when the width of the flow passage is b, the height of the flow passage is h, and b is larger than h.

Therefore, in the present invention, the regions of both ends of the flow passages of the porous members provided in the flow passages (the portions in contact with the ribs) were treated with the water repellent treatment, the action that the wall surfaces treated with the water repellent treatment repel the water that stayed and push it out to the center part of the flow passages was utilized, and the flow of the gaseous phase and the liquid phase was devised to evenly flow inside the flow passages.

How to determine the wall surface regions of the porous member where the water repellant treatment was performed so that the flow of the gaseous phase and the liquid phase evenly flow inside the flow passages was decided according to the procedure described below from the analytical result using simulation.

The analysis of the mixed phase flow of the reaction gas and the cooling water in the porous flow passages by simulation was carried out with the analytical condition shown in Table 1.

With reference to the present table, the simulation was carried out with the condition the same with the case of the analysis of FIG. 5 with the exceptions of the shape of the porous flow passages, that the inlet condition and the outlet condition were 9:1 in terms of the volumetric ratio of the air and the water, and the items in relation with the wall surface condition of the porous flow passages described below.

TABLE 1

```
Shape of porous flow passage: 4.5 mm × 1.0 mm ×+ 9.5 mm
  0.6 mm pore diameter, lattice array, 73% pore ratio
Inlet condition:
(1) reaction gas = air (normal state), cooling water = water (normal state)
(2) air/water volumetric ratio = 9:1
(3) flow velocity: 1.0 m/s
Outlet condition:
Spontaneously discharged to atmosphere.
Condition of selectively coating hydrophilic and water repellent coat
on the porous wall surfaces: four cases below
  a) hydrophilic for entire surface
  b) water repellent for entire surface
  c) water repellent for 20% in both sides of the flow passages
  (sandwiched constitution of 10% water repellent region +80%
hydrophilic region +10% water repellent region)
  d) water repellent for 40% in both sides of the flow passages
  (sandwiched constitution of 20% water repellent region +60%
hydrophilic region +20% water repellent region)
```

The wall surface condition of the porous flow passages will be described.

The object of the present simulation is to investigate how the water repellent treatment is to be performed on the porous members in order to make the reaction gas and the cooling water flow evenly inside the flow passages.

In the meantime, as described in the analytical result of FIG. 7, the water moves in the width direction of the flow passages and the water is present much in both ends of the flow passages when the width of the flow passage is b, the height of the flow passage is h, and b is larger than h. And therefore it is considered that the effect of the water repellent treatment in the width direction is stronger the effect of the water repellent treatment in the height direction. When the cross-section is taken orthogonal to the flow direction, the porous member 203 is with 4.5 mm width and 1.0 mm thickness (height), that means width (4.5)>height (1.0). Since the cooling water is considered to be directed more in the width direction, it was decided that both end regions in the width of the flow passages were to be treated with water repellent treatment.

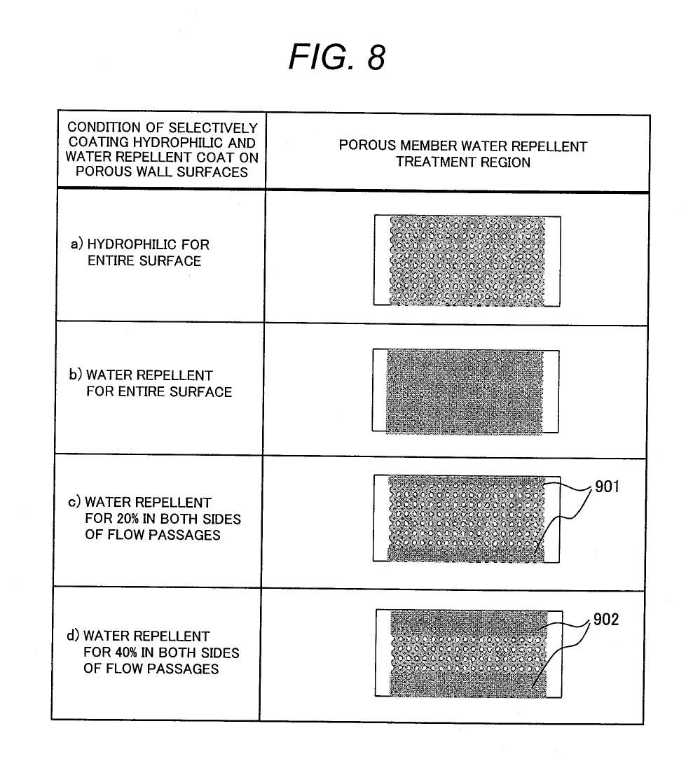

The water repellent treatment condition of the wall surfaces of the porous material is shown in FIG. 8.

In the present drawing, for comparison purpose, a) the case the entire wall surface of the porous material was treated with hydrophilic treatment, and b) the case entirely treated with water repellent treatment were taken up. Further, as the case in which the both end regions in the width direction of the flow passages were treated with water repellent treatment, c) the case 10% each of water repellent treatment regions 901 were formed in both sides of the flow passages and the ratio to the volume of the porous members became 20% in total and d) the case 20% each of water repellent treatment regions 902 were formed in both sides of the flow passages and the ratio to the volume of the porous members became 40% in total were also included, and the analysis of the mixed phase flow was carried out by simulation with respect to the four cases.

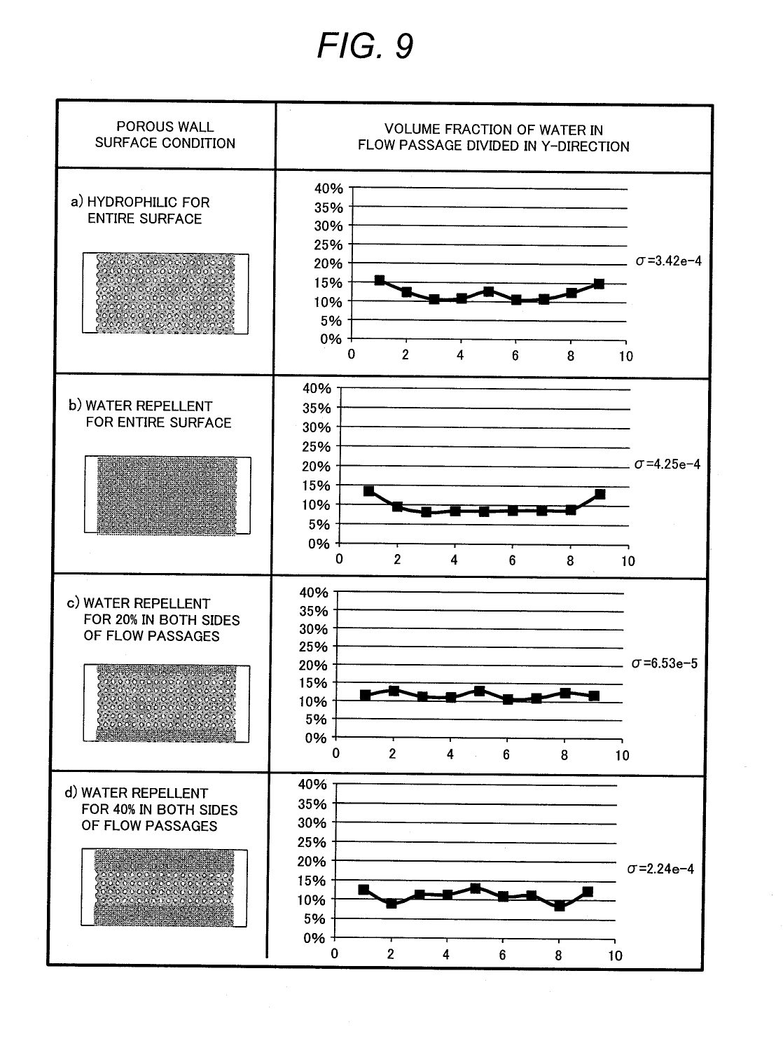

The analytical result is shown in FIG. 9.

With respect to each water repellent treatment condition of the wall surfaces of the porous material, the volume fractions of the water of respective divided flow passages were collected in the graph using the analytical method described in FIG. 7. In the graph, the value σ is an assumed value of the variance representing the size of variation of the volume fraction of the water from the average value, and the water is considered to be more evenly distributed when the value is smaller.

As a result of the present analysis, the case the water was considered to be most evenly distributed was the case 10% each of the water repellent treatment regions were set in both sides of the flow passages which was the above item c).

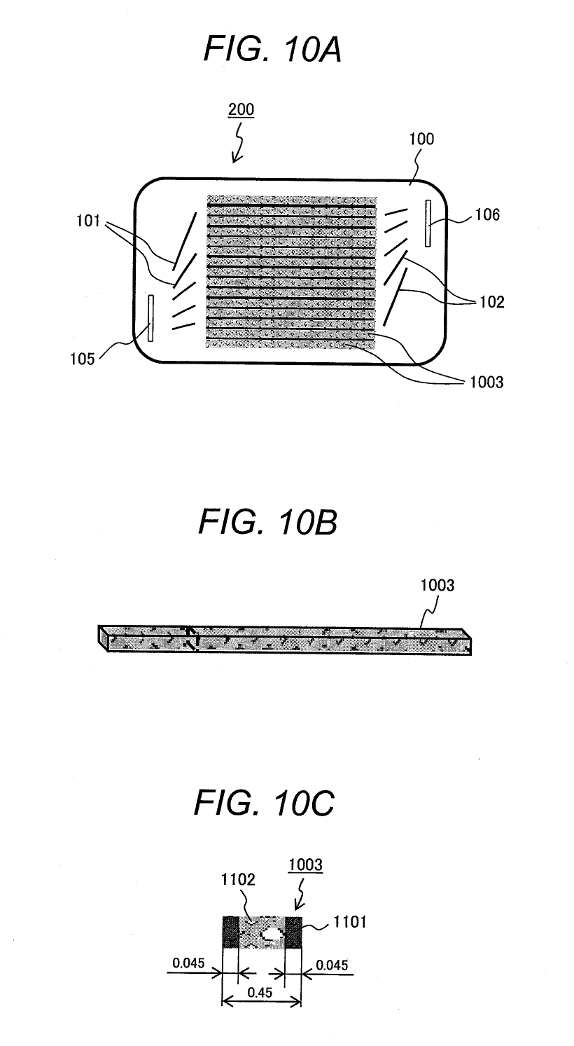

The separators for a fuel cell manufactured based on the analytical result of the above simulation are shown in FIG. 10A to FIG. 10C.

In the separator for a fuel cell 200 of FIG. 10A, a thin sheet of stainless steel SUS316 is used for a metal substrate (metal separator 100), and a foam metal made of nickel is used for porous members 1003. The pore diameter of the foam metal made of nickel is 0.2 mm, and the porosity is 95%.

FIG. 10B is a perspective view showing one piece of the porous member constituting the separator for a fuel cell of the present example. FIG. 10C is a cross-sectional view showing the internal structure of the porous member of FIG. 10B.

In FIG. 10C, the porous member 1003 is constituted of a water repellent portion 1101 and a hydrophilic portion 1102. In the present example, the water repellent portion 1101 is provided around the hydrophilic portion 1102.

When the porous member 1003 is with 120 mm length, 1.35 mm width and 0.3 mm height, in order to make the volume fraction of the water repellent treatment region (water repellent portion 1101) 20% in total in the vicinity of the both sides in contact with the wall surfaces of the flow passages, the water repellent treatment regions are set respectively in the regions of 0.045 mm from the wall surfaces. The water repellent treatment is performed by immersing the water repellent treatment region of the porous member in an emulsion liquid of a fluorine-based water repellent agent (D1 made by Daikin Industries, Ltd.) for example, and performing heat treatment for 10 min at 300° C. after drying.

Here, as the porous member 1003, aluminum foam, stainless steel foam, nickel foam and the like can be cited, and it is preferable that the porosity is 800 or more, and the pore diameter is 0.1 mm or more. With respect to the material, foam metal, stainless wool and the like are preferable. Also, as the water repellent treatment, coating of a water repellent treatment material such as Teflon (registered trademark) and the like and a patterning process such as ink jet printing, screen printing, masking and the like can be employed.

Below, other examples will be described.

An appropriate constitution can be selected based on the analysis of simulation according to the flow velocity of pouring in, the volumetric ratio of the reaction gas and the cooling water and the like.

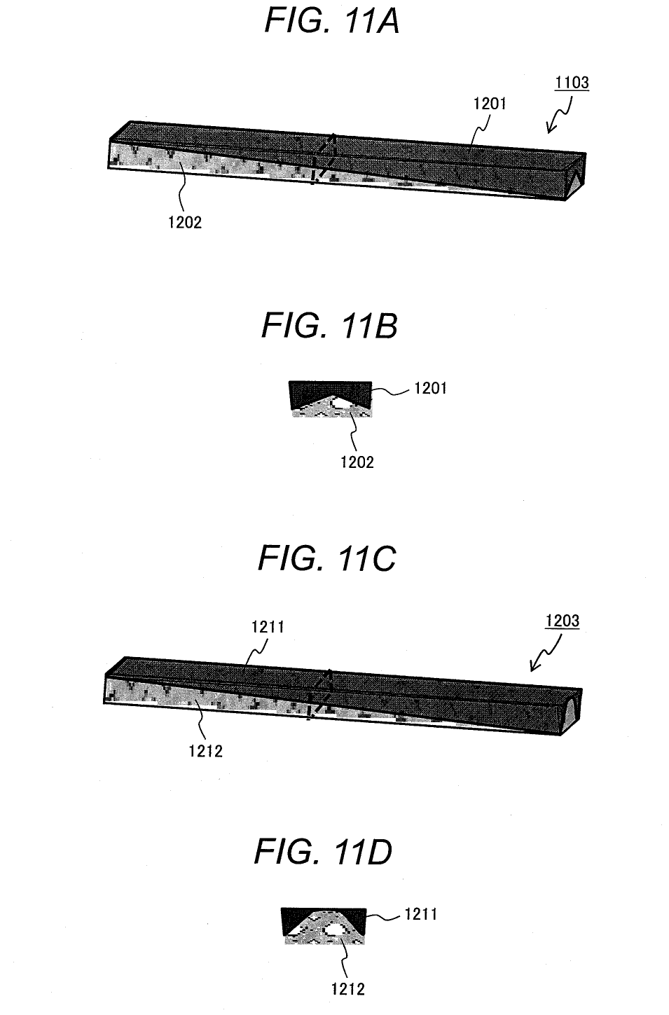

FIG. 11A and FIG. 11B are a perspective view and a cross-sectional view showing the constitution of the water repellent treatment region (water repellent portion) of a porous member of another example.

In these drawings, the porous member 1103 is constituted of a water repellent treatment region (water repellent portion 1201) and a hydrophilic portion 1202.

As shown in FIG. 11A, it is constituted so that the cross-sectional area of the water repellent portion 1201 increases and the cross-sectional area of the hydrophilic portion 1202 decreases from the inlet side (left side in the drawing) of the mixed phase flow toward the outlet side. Also, as shown in FIG. 11B, the cross-sectional shape of the water repellent portion 1201 is of a pentagonal shape having a recess, and the cross-sectional shape of the hydrophilic portion 1202 is of a pentagonal shape having a projection.

FIG. 11C and FIG. 11D are a perspective view and a cross-sectional view showing the constitution of the water repellent treatment region (water repellent portion) of the porous member of still another example.

In these drawings, the porous member 1203 is constituted of a water repellent treatment region (water repellent portion 1211) and a hydrophilic portion 1212.

As shown in FIG. 11C, the present example is also constituted so that the cross-sectional area of the water repellent portion 1211 increases and the cross-sectional area of the hydrophilic portion 1212 decreases from the inlet side (left side in the drawing) of the mixed phase flow toward the outlet side. Also, as shown in FIG. 11D, the cross-sectional shape of the water repellent portion 1211 has a recess, and the cross-sectional shape of the hydrophilic portion 1212 has a projection.

In general, because of condensation of the reaction generated water that gradually increases accompanying an electro-chemical reaction, the liquid phase increases, and the composition ratio of the liquid phase and the gaseous phase changes. Because of the constitution that the cross-sectional area of the water repellent portion 1211 increases and the cross-sectional area of the hydrophilic portion 1212 decreases from the inlet side toward the outlet side, it becomes possible to consider the effect of the change in the composition ratio due to the condensation of the reaction generated water accompanying the electro-chemical reaction.

On the other hand, when the vaporization amount of the cooling water accompanying the thermal transfer is larger than the increased amount of the liquid phase due to condensation of the reaction generated water, the liquid phase gradually decreases and the gaseous phase increases. The example of this case is of such a constitution of the porous member shown in FIG. 11A to FIG. 11D with the provision that the inlet and the outlet are reversed. Because of the constitution that the cross-sectional area of the water repellent portion 1211 decreases and the cross-sectional area of the hydrophilic portion 1212 increases from the inlet side toward the outlet side, it becomes possible to consider the effect of the change in the composition ratio due to decrease of the liquid phase accompanying the vaporization.

By such formation that the water repellent effect is enhanced in the regions of both ends of the flow passages where the water is present much, that is, in the vicinity of the position in contact with the wall surfaces of the flow passages in the porous member as described above, the water staying on the wall surfaces is repelled and is pushed out to the center part of the flow passages, therefore the flow of the gaseous phase and the liquid phase come to flow evenly inside the flow passages, and it becomes possible to reduce the drop of the cooling efficiency due to uneven cooling caused by uneven flow of the gaseous phase and the liquid phase as well as the problem that the cooling water covers the electrode portions and the reaction gas cannot be supplied to the electrodes.

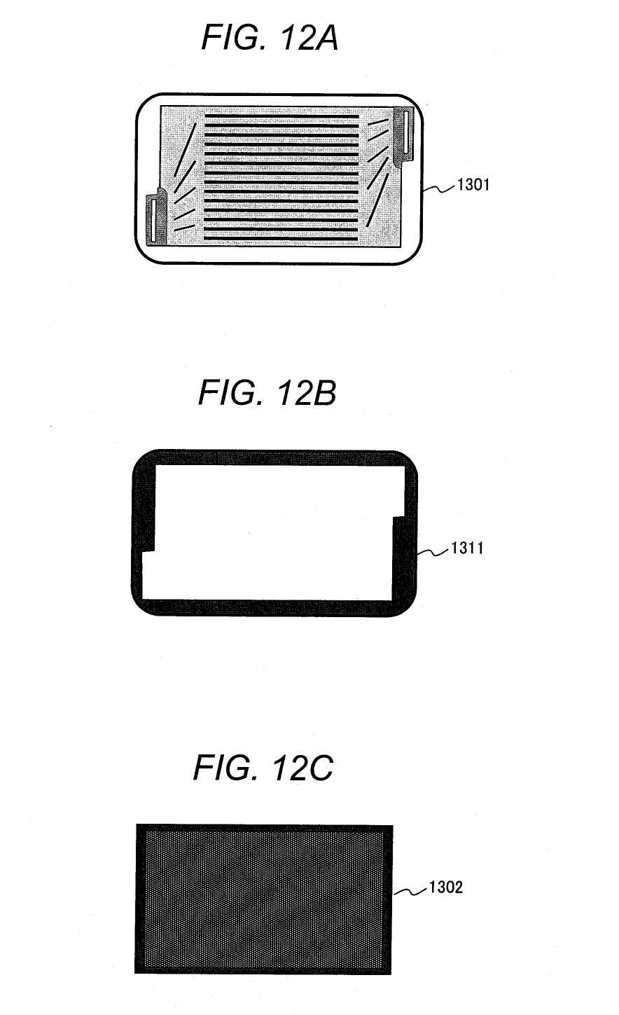

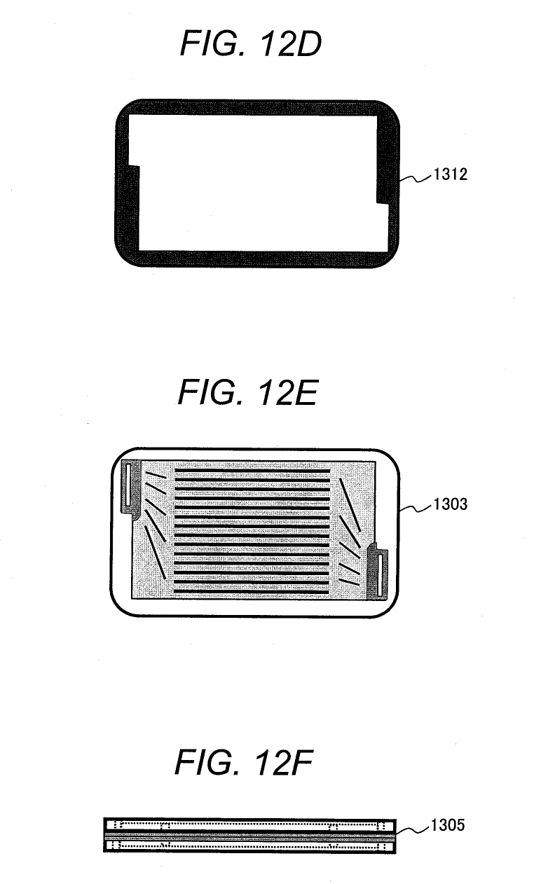

FIG. 12A to FIG. 12F are drawings explaining a cell for a fuel cell manufactured using a separator in relation with an aspect of the present invention.

For the separators, the separators 200 described in FIG. 2A to FIG. 2C are used.

A cell for a fuel cell is a basic unit for power generation, and is manufactured so as to sandwich a membrane-electrode assembly (MEA) 1302 by a fuel pole side separator 1301 and an air pole side separator 1303 from both sides. The membrane-electrode assembly (MEA) 1302 is required to have an enough size to cover the flow passage region of the separator 1301. For example, when the flow passage region is with 170 mm width and 90 mm height, the membrane-electrode assembly (MEA) 1302 also becomes with 170 mm width and 90 mm height. In respective poles, gaskets 1311 and 1312 are inserted between the separator and the MEA so that the gas does not leak. A side view of the cell for a fuel cell assembled is as per 1305 in FIG. 12F.

Next, the membrane-electrode assembly (MEA) 1302 will be described.

The MEA is constituted so that a cathode side electrode (oxygen pole) and an anode side electrode (fuel pole) sandwiches a solid polymer electrolyte membrane from both sides, a fluorine-based ion exchange membrane using an ion exchange membrane having protonic conductivity such as Nafion (registered trademark) 117 (thickness: 175 μm, made by DuPont) for example is used for the solid polymer electrolyte membrane, and the cathode side electrode and the anode side electrode are formed of a catalytic reaction layer and a diffusion layer respectively. A cathode side diffusion layer and an anode side diffusion layer enhance the diffusability of the fuel gas or the oxidant gas, and is required to have both of the function of discharging the reaction generated water generated by power generation and the electronic conductivity, and can employ a conductive porous material such as a carbon paper, carbon cloth, and the like for example treated with water repellent treatment. Here, a nonwoven carbon cloth (TGP-H060 made by Toray Industries, Inc.) with 0.2 mm thickness was used for the conductive porous material, and was immersed in an emulsion liquid of a fluorine-based water repellent agent (D1 made by Daikin Industries, Ltd.) in order to perform water repellent treatment, and was treated with heat treatment for 10 min at 350° C. after drying to form the diffusion layer.

The catalytic reaction layer is a thin membrane with approximately 0.005 mm thickness with the main compositions of conductive carbon particles carrying the catalyst metal and polymer electrolyte. For the anode side catalytic reaction layer, catalyst carrying particles for anode obtained by making Ketjen Black (made by Akzo Chemie) which is the conductive carbon particles with 30 nm average primary particle diameter carry platinum and ruthenium by 25 wt % respectively was used. Also, for the cathode side catalytic reaction layer, catalyst carrying particles for cathode obtained by making the Ketjen Black carry platinum by 50 wt % was used.

The cathode side catalytic reaction layer and the anode side catalytic reaction layer were formed by preparing the slurry for the cathode and the anode by mixing a solution in which respective catalyst carrying particles were dispersed in an isopropanol aqueous solution and a solution in which a polymer electrolyte such as Nafion 117 for example was dispersed in ethanol so that the weight ratio of the catalyst carrying particles and the polymer electrolyte became 1:1 and thereafter highly dispersing them by a beads mill, coating the cathode side diffusion layer and the anode side diffusion layer previously prepared with the slurry by a spray coater, and drying them for 6 hours at an ordinary temperature in the atmosphere.

Thus, the cathode side electrode and the anode side electrode were manufactured by forming the cathode side catalyst reaction layer and the anode side catalyst reaction layer on the respective diffusion layers.

What is claimed is:

1. A separator for a fuel cell comprising:
a metal substrate having projections; and
porous members provided in a plurality of flow passages partitioned by the projections,
wherein a hydrophilic portion is provided in a center part of a cross section orthogonal to a flow direction in the porous member; and
a water repellent portion is provided in at least a part of portions in contact with wall surfaces of the flow passages within a range of the cross section.

2. The separator according to claim 1,
wherein the water repellent portion is a region occupying 40% or less of the porous member in terms of a volumetric ratio, the water repellent portion is provided dividedly to both ends in the width direction, and
wherein a width of the water repellent portions in the both ends are 0.2×b or less respectively when a width of the cross section is b.

3. The separator according to claim 1,
wherein the water repellent portion is a region occupying 40% or less of the porous member in terms of a volumetric ratio, and is arranged so that the volumetric ratio of the water repellent portion becomes constant, increases, or decreases toward a downstream side in the flow direction.

4. The separator according to claim 1, wherein a height of the cross section is a depth of the flow passages or less.

5. A fuel cell comprising:
a membrane-electrode assembly which includes a fuel pole, an oxygen pole and a solid polymer electrolyte membrane and has a constitution of interposing the solid polymer electrolyte membrane between the fuel pole and the oxygen pole;
a fuel pole separator having a fuel gas flow passage along the fuel pole and electrically connected to the fuel pole; and
an oxygen pole separator having an oxidant gas flow passage along the oxygen pole and electrically connected to the oxygen pole,
wherein the fuel pole separator or the oxygen pole separator is the separator according to claim 1.
